(19) United States
(12) Patent Application Publication
(10) Pub. No.: US 2023/0332313 A1
(43) Pub. Date: Oct. 19, 2023

(54) VOLTAGE AND FREQUENCY RESPONSE AND REGULATION IN A HYDROGEN GENERATION SYSTEM

(71) Applicant: Ohmium International, Inc., Incline Village, NV (US)

(72) Inventors: Chockkalingam Karuppaiah, Fremont, CA (US); Rasool Aghatehrani, Redwood City, CA (US); Anil Kumar Adapa, Tadepalligudem (IN)

(21) Appl. No.: 18/135,902

(22) Filed: Apr. 18, 2023

Related U.S. Application Data
(60) Provisional application No. 63/332,146, filed on Apr. 18, 2022.

(51) Int. Cl. C25B 15/02; C25B 9/65; C25B 1/04

(52) U.S. Cl. CPC C25B 15/02; C25B 9/65; C25B 1/04

(57) ABSTRACT

The systems and methods described herein provide for control of hydrogen generation based on one or more characteristics of an input power signals, including a voltage of the input power signal and/or a frequency of the input power signal. The hydrogen generation system may be controlled in response to a reactive power consumption of the hydrogen generation system and/or a reactive power component of a power grid providing energy to the hydrogen generation system. In one embodiment, the hydrogen generation system may be controlled to generate reactive power in circumstances in which a voltage an input power signal is less than or more than a voltage range. In another embodiment, the hydrogen generation system may control hydrogen production based on a frequency of the input power signal.

### CROSS-REFERENCE TO RELATED APPLICATIONS

This application claims the benefit of U.S. Provisional Patent Application No. 63/332,146 entitled “VOLTAGE AND FREQUENCY RESPONSE AND REGULATION”, filed on Apr. 18, 2022, the entire contents of which are incorporated herein by reference.

### FIELD OF THE DISCLOSURE

The present disclosure is generally related to a hydrogen generation system that includes control methods and systems for voltage and frequency response.

### BACKGROUND

Electrolysis (i.e., in the context of clean carbon production in the form of hydrogen) is a rapidly growing and enabling technology that provides a preferable and sustainable alternative to fossil fuels and the resulting environmentally harmful CO2 emissions. Electrolysis may be described as the process of using electricity to split water into hydrogen and oxygen, with this reaction taking place in a unit called an “electrolyzer.”

Through electrolysis, the electrolyzer system creates hydrogen gas which may be used as an energy source, such as in hydrogen-powered vehicles. The leftover oxygen is released into the atmosphere or can be captured or stored to supply other industrial processes or even medical gases in some cases. The hydrogen gas can either be stored as a compressed gas or liquefied, and since hydrogen is an energy carrier, it can be used to power any hydrogen fuel cell electric application, whether it's trains, buses, trucks, or data centers. The commercial interest in hydrogen fuel (commonly referred to as the fuel cell) is increasing due to the amount of heat that is produced during the electrochemical process.

During this process, hydrogen atoms react with oxygen atoms to form water during oxidation; electrons are released in the process and flow as an electric current through an external circuit. Hydrogen fuel uses the chemical energy of hydrogen to produce electricity as a clean form of energy, with electricity, heat, and water vapor being the only products and byproducts. This process produces zero carbon dioxide, a critical key to reducing greenhouse emissions. Hydrogen fuel cells offer a variety of applications, providing power for automobiles, aircraft, seagoing vessels, and emergency backup power supplies. Hydrogen fuel has additional uses for large stationary (industrial) as well as mobile/portable (personal) applications. Storing hydrogen (I.e., in cryogenic or high-pressure tanks) may present a gating issue in certain applications.

Hydrogen generators are often powered through a connection to a local power grid, which may be referred to as “utilities”. Such utilities may supply electrical power to multiple consumers at the same time, often in the form of alternating electrical current (AC). One or more of the utility customers may include devices or components that generate a reactive power component of the provided power. However, reactive power may be undesirable on a power grid. Power-producing (and/or power-distributing) entities may therefore penalize power consumers for any net imbalance to the power grid caused by the power consumers. Thus, it may be desirable for power consumers to balance their reactive power generation and consumption, e.g., to have near net-zero reactive power generation and consumption and, in some instances, may receive credits for providing reactive power back to the grid to aid the grid in balancing the reactive power. This power factor correction may improve the operation of both consumer devices receiving power from a power grid and the power grid itself.

### SUMMARY

According to one embodiment, a hydrogen generation system includes an electrochemical stack producing hydrogen, a power source receiving an input power signal from an input energy source and in electrical communication with the electrochemical stack, and a control system comprising a processor and a non-transitory computer-readable medium encoded with instructions. When those instructions are executed, the processor may determine a value of a characteristic of the input power signal received from the input energy source, obtain a pre-determined range of values of the hydrogen generator corresponding to the characteristic of the input power signal, the pre-determined range of values comprising an upper threshold value of the characteristic and a lower threshold value of the characteristic, and alter, based on the value of the characteristic of the input power signal being greater than the upper threshold value of the characteristic or less than the lower threshold value of the characteristic, a consumption of reactive power of the input energy source by the hydrogen generator.

According to another embodiment, a method of controlling a hydrogen generation system comprises controlling a reactive power consumed by a hydrogen generator receiving an input power signal from an input energy source, the hydrogen generator comprising an electrochemical stack producing hydrogen and a power source receiving the input power signal from the input energy source and in electrical communication with the electrochemical stack. The method further includes the operations of determining a value of a characteristic of the input power signal received from the input energy source, determining a range of values of the hydrogen generator corresponding to the characteristic of the input power signal, the range of values comprising an upper threshold value of the characteristic and a lower threshold value of the characteristic, and transmitting, to the hydrogen generator, one or more instructions to alter, based on the value of the characteristic of the input power signal being greater than the upper threshold value of the characteristic or less than the lower threshold value of the characteristic, a consumption of reactive power of the input energy source by the hydrogen generator.

According to yet another embodiment, a non-transitory computer-readable storage medium may have computer-executable program instructions stored thereon. When executed by a processor, the program instructions cause a computing device to perform the operation of controlling a reactive power consumed by a hydrogen generator receiving an input power signal from an input energy source, the hydrogen generator comprising an electrochemical stack producing hydrogen and a power source receiving the input power signal from the input energy source and in electrical communication with the electrochemical stack. The method further includes the operations of determining a value of a characteristic of the input power signal received from the input energy source, determining a range of values of the hydrogen generator corresponding to the characteristic of the input power signal, the range of values comprising an upper threshold value of the characteristic and a lower threshold value of the characteristic, and transmitting, to the hydrogen generator, one or more instructions to alter, based on the value of the characteristic of the input power signal being greater than the upper threshold value of the characteristic or less than the lower threshold value of the characteristic, a consumption of reactive power of the input energy source by the hydrogen generator.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates shows an exemplary environment for hydrogen production according to aspects of the present disclosure.

FIG. 2 illustrates an embodiment of a hydrogen generator for providing hydrogen to one or more downstream receivers.

FIG. 3 illustrates an example block diagram of a controller for a hydrogen generation system to regulate power to the system in response to input voltage and/or frequency.

FIG. 4 illustrates a flowchart of a method for adjusting a reactive power generated or consumed by a hydrogen generation system in response to an input voltage.

FIG. 5A is a graph illustrating input voltage versus reactive power of a hydrogen generation system.

FIG. 5B is a graph illustrating input frequency versus production of a hydrogen generation system.

FIG. 6 illustrates a flowchart of a method for adjusting a production of a hydrogen generation system in response to a frequency of an input power signal.

FIG. 7 illustrates an exemplary computing system which may be used in implementing embodiments of the present disclosure.

### DETAILED DESCRIPTION

The systems and methods described herein provide high-precision control of hydrogen generation. In particular, the systems and methods provide for controlling a hydrogen generation system based on one or more characteristics of an input power signals, including but not limited to a voltage of the input power signal and/or a frequency of the input power signal. In one implementation, the hydrogen generation system may be controlled in response to a reactive power consumption of the hydrogen generation system and/or a reactive power component of a power grid providing energy to the hydrogen generation system. In one embodiment, the hydrogen generation system may be controlled to generate reactive power in circumstances in which a voltage an input power signal is less than a pre-determined lower threshold voltage value. The hydrogen generation system may also be controlled to consume reactive power in circumstances in which a voltage of an input power signal is greater than a pre-determined upper threshold voltage value. The amount of reactive power generated or consumed may be based on a voltage control policy implemented by the hydrogen generation system. In another embodiment or in addition to the first embodiment, the hydrogen generation system may be controlled to increase hydrogen production in circumstances in which a frequency of the input power signal is less than a pre-determined lower threshold value. The hydrogen generation system may also be controlled to reduce hydrogen production in circumstances in which a frequency of the input power signal is greater than a pre-determined upper threshold value. The amount of change in the hydrogen production may be based on a frequency control policy implemented by the hydrogen generation system.

Some embodiments of this disclosure, illustrating its features, will now be discussed in detail. It can be understood that the embodiments are intended to be open-ended in that an item or items used in the embodiments is not meant to be an exhaustive listing of such items or items or meant to be limited to only the listed item or items.

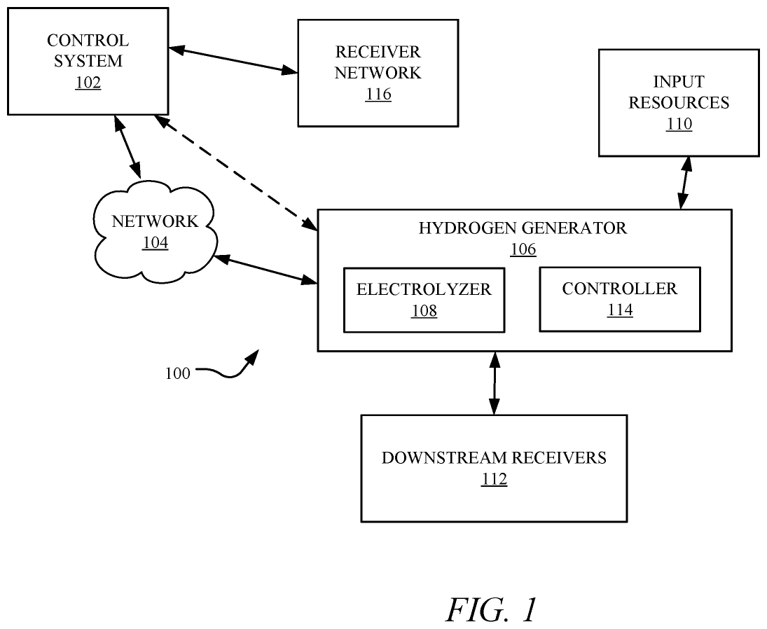

FIG. 1 shows an exemplary environment 100 for hydrogen production according to aspects of the present disclosure. The environment 100 may include more or fewer components than illustrated in FIG. 1, which is included to provide context for the operations and configurations described herein. Additional components and/or configurations of the hydrogen production environment 100 are described in greater detail below.

The environment 100 may include a hydrogen generator 106 designed and configured to generate hydrogen. The hydrogen generator 106 may include a system housed in a container, outdoor-rated cabinets, or multiple systems contained within a site. In one implementation, the hydrogen generator 106 may be a clean hydrogen facility. Such clean hydrogen facility installations are at the early stages of the industry with a significant market growth projection that may scale to much larger production capacity and higher integration adaptation to the upstream and downstream required configurations over time.

As described above, the hydrogen generator 106 generates hydrogen through electrolysis and, more particularly, an electrolyzer or electrolyzer stack 108. The electrolyzer stack 108 is the key equipment component in the hydrogen production process. The quality of the electrolyzer stack 108 determines the operational safety and stability of hydrogen production equipment. The electrolyzer equipment is comprised of various electrolytic cells, and every cell is composed of the main electrode plates, positive net, seal diaphragm gasket, and negative net. An electrolyzer stack, by comparison, comprises multiple cells connected in series in a bipolar design. The stacked bipolar electrolyzer 108 offers a technological engineering solution for the mass production of electrodeposited conducting polymer electrodes for supercapacitors

Most electrolyzers 108 include an anode and a cathode separated by an electrolyte or membrane in the presence of water. As energy, such as a direct-current (DC) power, is applied, the water molecules react at the anode to form oxygen and positively charged hydrogen ions. With the support of an electrolyzer 108, hydrogen and oxygen may be created from a pure water supply and electrical current. Hydrogen can then be utilized to power a fuel cell stack. In particular, hydrogen ions may flow through the electrolyte of the electrolyzer 108 to the cathode to bond with electrons and form hydrogen gas. The leftover oxygen may be released into the atmosphere or can be captured or stored to supply other industrial processes or even medical gases, in some cases. The hydrogen gas can either be stored as a compressed gas or liquefied, and since hydrogen is an energy carrier, it can be used to power such downstream receivers 112 as hydrogen fuel cell applications like trains, buses, trucks, or data centers. In some instances, the generated hydrogen may be provided to one or more downstream industrial plants for asset production, such as steel, cement, oil, fertilizer, and the like. In one example, liquefied hydrogen may be piped to a downstream receiver 112 or carried by tanker.

Electrolyzers 108 can range in size from small equipment, well-suited for modest-scale distributed hydrogen production to large-scale, central production facilities, capable of being sequenced directly to renewable or other non-greenhouse-gas-emitting forms of electricity production. Electrolyzers 108 offer a route to produce clean hydrogen to power hydrogen fuel cells, supply industrial processes or produce green chemicals like fertilizers, renewable natural gas, and methanol.

As should be appreciated, the hydrogen generator 106 may utilize several input resources 110 for generation of hydrogen. For example, various forms of energy sources (grid electricity, natural gas, wind, solar, hydro, etc.) may be provided to the hydrogen facility for use by the components of the generator. Other input resources 110, such as water for use by the electrolyzer 108 may also be provided to the hydrogen generator 106 for producing hydrogen. In one particular implementation, a power grid may be an input power resource 110 to the hydrogen generator 106. The power grid may supply electrical power, in the form of alternating electrical current (AC) to power the components of the hydrogen generator 106. As discussed in more detail below, systems or devices connected to the power grid 106 may include resistive elements and reactive elements. However, reactive power may be undesirable on a power grid. Power-producing (and/or power-distributing) entities may penalize power consumers for any net imbalance to the power grid caused by the power consumers. Thus, it may be desirable for power consumers to balance their reactive power generation and consumption, e.g., to have near net-zero reactive power generation and consumption and, in some instances, may receive credits for providing reactive power back to the grid to aid the grid in balancing the reactive power.

The hydrogen generator 106 may include several components in addition to the electrolyzer 108. Control over the various components, systems, programs, and/or sensors of the generator 106 may be executed through a controller 114. For example, a Supervisory Control and Data Acquisition (SCADA) control system 114 may be integrated with the hydrogen generator 106 to monitor generator conditions and/or control various aspects or parameters of the components of the generator. In one particular instance, a sensor may be associated with a pipe containing gas generated from the electrolysis process to measure the pressure within the pipe. The sensor may provide readings or measurements to the controller 114 which may, in response, adjust one or more valves within the gas piping system to adjust the pressure within the piping system. In general, any adjustable aspect or parameter of the hydrogen generator, the components within the generator, input resources 110, sensors, executable program associated with the generator, or any other aspect of the hydrogen generator 106 may be adjustable by the controller 114. In some instances, the controller 114 may also include an interface through which a generator operator may access components of the generator 106 and make one or more adjustments to the components. In another instance, the controller 114 may be configured to automatically adjust the parameters or aspects of the hydrogen generator 106 based on inputs from one or more sensors or any other source of operational data of the generator. Additional details of the controller 114 and the hydrogen generator 106 in general are discussed in more detail below.

The environment 100 may also, in some instances, include a remote or separate control system 102 that communicates with the hydrogen generator 106 either directly or through a network 104 connection. In one example, the control system 102 may be in communication with the electrolyzer 108 to monitor one or more operational states of the electrolyzer and adjust one or more parameters of the electrolyzer accordingly. In other examples, the control system 102 may be in communication with a plurality of hydrogen generators 106 connected together or separate. In general, the control system 102 may be in communication with any number of hydrogen generators 106, each of which may generate some hydrogen as controlled by the control system 102 or by a local controller for the hydrogen generator. The plurality of hydrogen generators may therefore be controlled by the control system 102 to provide a requested amount of hydrogen for one or more downstream receivers 112.

The network 104 may connect the control system 102 to one or more communication interface devices of the hydrogen generator 106 and may be configured to transmit and/or receive information between the remote monitoring system and other devices by way of one or more wired or wireless communication networks or connections. Examples of such networks or connections include, without limitation, wireline communication over serial or Ethernet in copper or fiber medium or wireless communication over USB, Wi-Fi, Bluetooth, Zigbee mesh network, or a cellular wireless network. One or more such communication interface devices may be utilized to communicate with the remote monitoring system 102 and/or the hydrogen generator 106, either directly over a point-to-point communication path, over a wide area network (WAN) (e.g., the Internet), over a local area network (LAN), over a cellular (e.g., third generation (3G), fourth generation (4G), fifth generation (5G)) network, or over another communication means. In some instances, the control system 102 may directly connect to the hydrogen generator 106, such as through a cable connection or backplane connection between the control system and the generator.

The environment 100 of FIG. 1 may also include a receiver network 116 or customer network, which allows receivers of the generated hydrogen to provide requests for hydrogen to the control system 102 or to communicate with the control system in any manner. The receiver network 116 generally allows receivers or users to share information or data with the control system 102 and/or controller 114. For example, the receiver network 116 may receive a request for hydrogen from a system or user associated with a downstream receiver 112. A request module of the receiver network 116 may generate and send a request to the control system 102 activate the electrolyzer 108 of the hydrogen generator 106 to generate hydrogen for the downstream receiver. The receiver network 116 may also include one or more databases storing information associated with the request and receipt of hydrogen from the hydrogen generator 106, such as a client name, the number of electrochemical stacks the customer is currently associated with, and current and past requests for hydrogen, including an amount requested, the date, and the time. Such information may also be maintained by the control system 102 for one or many downstream receivers 112. In other examples, hydrogen requests may be automated by the receiver network 116 and transmitted to the control system 102 either periodically or aperiodically, such as in response to one or more operating conditions of the downstream receiver 112.

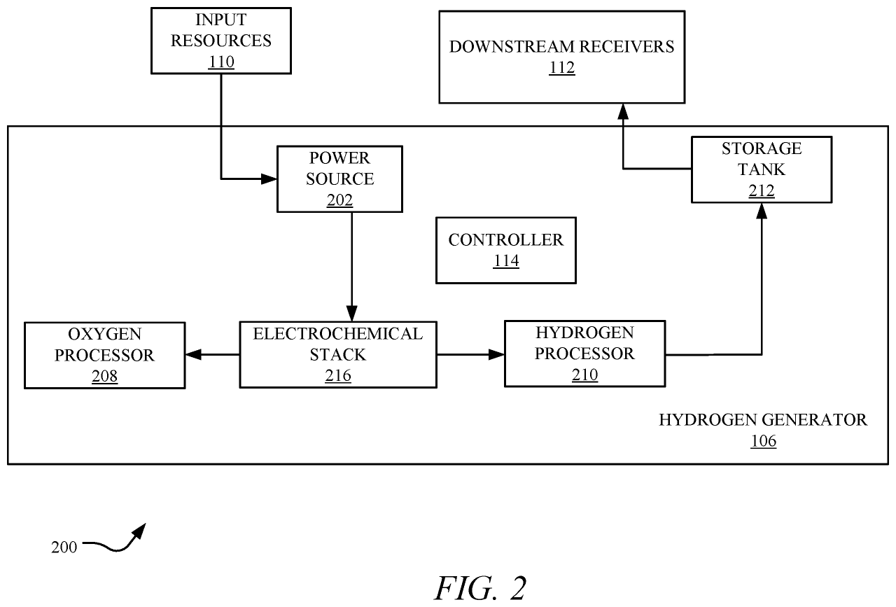

FIG. 2 illustrates an embodiment of the hydrogen generator 106 of the environment 100 discussed above for providing hydrogen to one or more downstream receivers 112, such as industrial plants or other receivers. The hydrogen generator 106 may be the same or similar to that described above with reference to FIG. 1. However, in this illustration, additional components of the hydrogen generator 106 is illustrated, such as an oxygen processor 208, a hydrogen processor 210, an electrochemical stack 216 (which may include an electrolyzer 108 as discussed above), one or more gas sensors, and one or more input power sensors (such as a voltmeter or other input voltage measuring device). The oxygen processor 208, the electrochemical stack 216, and the hydrogen processor 210 are fluidically isolated from each other with at least one fluid connector fluidly connecting the oxygen processor and the electrochemical stack and at least one fluid connector fluidly connecting the electrochemical stack and the hydrogen processor. As further discussed below, the hydrogen generator 106 may also include a power source 202, a plurality of gas movers, a controller 114, and a storage tank 212, among other components and systems.

In some instances, the electrochemical stack 216 may include a first membrane electrode assembly (MEA), a second membrane electrode assembly (MEA), and a bipolar plate that collectively defines two complete electrochemical cells for hydrogen generation. The electrochemical stack 216 may also include a first end plate and a second end plate that may sandwich the first MEA, the second MEA, and the bipolar plate into contact with one another and direct the flow of fluids into and out of the electrochemical stack. While the electrochemical stack 216 is described as including two complete cells—a single bipolar plate and two MEAs—it should be appreciated that this is for the sake of clarity of explanation only. The electrochemical stack 216 may alternatively include any number of MEAs and bipolar plates useful for meeting the hydrogen generation demands of the system 200 while maintaining separation between pressurized hydrogen and lower pressure water and oxygen flowing through the electrochemical stack, unless otherwise specified or made clear from the context. The electrochemical stack 216 may include more than one bipolar plate, a single MEA, and/or more than two MEAs. In some embodiments, the bipolar plate may be disposed between the first end plate and the first MEA and/or between the second end plate and the second MEA, without departing from the scope of the present disclosure.

In some embodiments, the first MEA and the second MEA of the electrochemical stack 216 may be identical. For example, the first MEA may include an anode, a cathode, and a proton exchange membrane (e.g., a PEM electrolyte) therebetween. Similarly, the second MEA may include an anode, a cathode, and a proton exchange membrane therebetween. The anodes may each comprise an anode catalyst (i.e., electrode) contacting the membrane and an optional anode fluid diffusion layer. The cathodes may each comprise a cathode catalyst (i.e., electrode) contacting the membrane and an optional cathode gas diffusion layer. The anode electrode may comprise any suitable anode catalyst, such as an iridium layer. The anode fluid diffusion layer may comprise a porous material, mesh or weave, such as a porous titanium sheet or a porous carbon sheet. The cathode electrode may comprise any suitable cathode catalyst, such as a platinum layer. The cathode gas diffusion layer may comprise porous carbon. Other noble metal catalyst layers may also be used for the anode and/or cathode electrodes, including but not limited to ruthenium, rhodium, palladium, osmium, iridium, gold, and silver. The electrolyte may comprise any suitable proton exchange (e.g., hydrogen ion transport) polymer membrane.

The bipolar plate may be disposed between the cathode of the first MEA and the anode of the second MEA. In general, the bipolar plate may include a substrate, an anode gasket, and a cathode gasket. The substrate has an anode (i.e., water) side and a cathode (i.e., hydrogen) side opposite one another. The anode gasket may be fixed to the anode side of the substrate, and the cathode gasket may be fixed to the cathode side of the substrate. Such fixed positioning of the anode gasket and the cathode gasket on opposite sides of the substrate may facilitate forming two seals that are consistently placed relative to one another and relative to the first MEA and the second MEA on either side of the bipolar plate. The gaskets form a double seal around the active areas (i.e., anode (e.g., water) flow field and cathode (e.g., hydrogen) flow field) located on respective opposite sides of the bipolar plate. Further, or instead, in instances in which an electrochemical stack 216 includes an instance of an MEA between two instances of the bipolar plate, the anode gasket and the cathode gasket may form a double seal along an active area of the MEA. Thus, more generally, it shall be appreciated that the anode gasket and the cathode gasket may form a sealing engagement with one or more MEAs in an electrochemical stack to isolate flows within the electrode stack and, thus, reduce the likelihood that pressurized hydrogen may inadvertently mix with a flow of water and oxygen exiting the electrochemical stack 216 to create a combustible hydrogen-oxygen mixture in the system 200.

The substrate may be formed of any one or more of various types of materials that are electrically conductive, thermally conductive, and have strength suitable for withstanding the high pressure of hydrogen flowing along the cathode side of the substrate during use. Thus, for example, the substrate may be at least partially formed of one or more of plasticized graphite or carbon composite. Further, or instead, the substrate may be advantageously formed of one or more materials suitable for withstanding prolonged exposure to water on the anode side of the substrate. Accordingly, in some instances, the anode side of the substrate may include an oxidation inhibitor coating that is electrically conductive, examples of which include titanium, titanium oxide, titanium nitride, or a combination thereof. The oxidation inhibitor may generally extend at least along those portions of the anode side of the substrate exposed to water during the operation of the electrochemical stack 216. The oxidation inhibitor may extend at least along the anode flow field inside the anode gasket on the anode side of the substrate. In some implementations, the oxide inhibitor may extend along the plurality of anode ports (i.e., water riser openings) which extend from the anode side to the cathode side of the substrate. The oxidation inhibitor may also be located in the anode plenums, which connect the anode ports to the anode flow field on the anode side of the substrate.

A cathode ring seal may be located around each cathode port (i.e., hydrogen riser opening) on the anode side of the substrate of the electrochemical stack 216. The cathode ring seal prevents hydrogen from leaking out into the anode flow field on the anode side of the substrate. In contrast, an anode ring seal may be located around each one or more anode ports on the cathode side of the substrate. For example, two anode ports are surrounded by a common anode ring seal to prevent water from flowing into the cathode flow field on the cathode side of the substrate.

The anode flow field may include a plurality of straight and/or curved ribs separated by flow channels oriented to direct a liquid (e.g., purified water) between at least some of the plurality of anode ports, such as may be useful for evenly distributing purified water along the anode of the second MEA. The anode gasket may circumscribe the anode flow field and the plurality of anode ports along the anode side of the substrate to limit the movement of purified water moving along the anode. The anode side of the substrate may be in sealed engagement with the anode of the second MEA via the anode gasket, such that anode channels are located therebetween. Under pressure provided by a source external to the electrochemical stack 216 (e.g., such as the pump of the oxygen processor 208), a liquid provided from the first fluid connector flows along the anode channels is directed across the anode of the second MEA, from one instance of the plurality of anode ports to another instance of the plurality of anode ports, where the liquid (e.g., remaining water and oxygen) may be directed out of the electrochemical stack through a third fluid connector.

Additionally, the substrate may include a plurality of cathode ports (i.e., hydrogen riser openings), each extending from the anode side to the cathode side of the substrate. The cathode side of the substrate may include a cathode flow field. The cathode flow field may include a plurality of straight and/or curved ribs separated by cathode flow channels oriented to direct gas (e.g., hydrogen) toward the plurality of cathode ports, which may be useful for directing pressurized hydrogen formed along with the cathode of the first MEA. Cathode plenums may be located between the cathode ports and the cathode flow field. The cathode gasket may circumscribe the cathode flow field, the cathode plenums, and the plurality of cathode ports along the cathode side of the substrate to limit movement of the pressurized hydrogen along the cathode. For example, the cathode side of the substrate may be in sealed engagement with the cathode of the first MEA via the cathode gasket, such that the cathode flow channels are defined between the cathode of the first MEA and the cathode side of the substrate. The pressure of the hydrogen formed along the cathode may move the hydrogen along at least a portion of the cathode channels and toward the cathode ports located diagonally opposite the cathode inlet port. The pressurized hydrogen may flow out of the cathode ports and out of the electrochemical stack 216 through the second fluid connector to be processed by the hydrogen circuit.

The anode gasket on the anode side of the substrate and the cathode gasket on the cathode side of the substrate may have different shapes. For example, the anode gasket may extend between the plurality of anode ports and the plurality of cathode ports on the anode side of the substrate. In other words, the anode gasket surrounds the anode ports and the anode flow field on one lateral side but leaves the cathode portions outside its circumscribed area. Therefore, the anode gasket may fluidically isolate anode flow from cathode flow in an installed position.

In contrast, the cathode gasket on the cathode side of the substrate may not extend between the plurality of anode ports and the plurality of cathode ports. In other words, the cathode gasket surrounds the anode ports, the cathode portions, and the cathode flow field. Instead, the anode ring seals isolate the anode ports from the cathode ports and the cathode flow field on the cathode side of the substrate.

In one configuration, the anode flow field and the cathode flow field may have the same shape, albeit on the opposite side of the substrate, to provide the same active area along with the first MEA and the second MEA. Thus, taken together, it shall be appreciated that the differences in shape between the anode gasket and the cathode gasket along with positioning of the anode ring seals and the same shape of the anode flow field and the cathode flow field may result in different sealed areas. These different sealed areas are complementary to one another to facilitate fluidically isolating the lower pressure flow of purified water along the anode channels from the pressurized hydrogen flowing along the cathode channels while nevertheless allowing each flow to move through the electrochemical stack 216 and ultimately exit the electrochemical stack along different channels.

In certain implementations, the cathode flow field may be shaped such that a minimum bounding rectangle of the cathode flow field is square. As used in this context, the term “minimum bounding rectangle” shall be understood to be a minimum rectangle defined by the maximum x- and y-dimensions of a cross-section of the cathode flow field. The plurality of cathode ports may include two cathode ports per substrate which are located in diagonally opposite corners from one another with respect to the minimum bounding rectangle (e.g., within the minimum bounding rectangle). The other two diagonally opposite corners lack the cathode ports. In instances in which the minimum bounding rectangle is square, the diagonal positioning of the cathode ports relative to the minimum bounding rectangle may facilitate the flow of pressurized hydrogen diagonally along the entire cathode flow field while leaving a large margin of the substrate material for strengths against the contained internal hydrogen pressure. Alternatively, the substrate may be a rectangle. The plurality of cathode ports may be positioned away from the edges of the substrate such that each one of the plurality of cathode ports is well-reinforced by the material of the substrate between the respective one of the plurality of cathode ports and the closest edge of the substrate.

Given the large pressure differential between the flow of pressurized hydrogen along the cathode channels and the flow of water and oxygen along the anode channels, the electrochemical stack 216 may include the anode fluid diffusion layer disposed in the anode channels and optionally between the anode electrode of the anode of the second MEA and the anode side (e.g., anode ribs) of the substrate. The porous material of the anode fluid diffusion layer may generally permit the flow of water and oxygen through the anode channels without a substantial increase in flow restriction through the anode channels while providing structural support on the anode side of the substrate to resist collapse that may result from the pressure difference on opposite sides of the substrate. It shall be understood, however, the that porous material may be disposed inside all of the anode channels in certain implementations.

Having described various features of the electrochemical stack 216, attention is now directed to a description of the operation of the electrochemical stack to form pressurized hydrogen with water and electricity as inputs. In particular, an electric field E (i.e., voltage) may be applied across the electrochemical stack 216 (i.e., between the end plates) from the power source 202. The bipolar plate may electrically connect the first MEA and the second MEA in series with one another such that electrolysis may take place at the first MEA and the second MEA to form a flow of pressurized hydrogen that is fluidically isolated from lower pressure water and oxygen, except for proton exchange occurring through the proton exchange.

Purified water (not shown) may be introduced into the electrochemical stack 216 via a fluid connection between the oxygen processor and electrochemical stack. Within the electrochemical stack 216, the purified water may flow along an intake channel to direct the purified water to the anode of the first MEA and the anode of the second MEA. With the electric field E applied across the anode and the cathode of the first MEA, the purified water may break down along the anode into protons (W) and oxygen. The protons (W) may move through the proton exchange membrane from the anode to the cathode. At the cathode, the protons (W) may combine to form pressurized hydrogen along the cathode. Through an analogous process, pressurized hydrogen may also be formed along the cathode of the second MEA. The flows of pressurized hydrogen formed by each of the first MEA and the second MEA may combine and flow out of the electrochemical stack 216 via two hydrogen exhaust channels that extends through the bipolar plate, among other components, to ultimately direct the pressurized hydrogen toward the hydrogen processor 210. The flows of oxygen and water along the first anode and the second anode may combine and flow out of the electrochemical stack 216 via the outlet anode ports and an outlet channel to direct this stream of water and oxygen toward the oxygen processor 208.

Some implementations of the hydrogen generator 106 may include a plurality of gas movers that include one or more of various types of fans (e.g., purge fans), blowers, or compressors. In some implementations, each one of the plurality of gas movers may be disposed within the electrochemical stack 216 or, alternatively, each one of the plurality of gas movers may be mounted externally to the electrochemical stack (e.g., to the roof or sidewall of the cabinet) to reduce the potential for heat or sparks to act as an inadvertent ignition source for contents of the generator.

As described above, the hydrogen generator 106 may also include a controller 114, which may be in electrical communication at least with one or more components of the generator. In general, the controller 114 may include one or more processors and a non-transitory computer-readable storage medium having stored thereon instructions for causing the one or more processors to control one or more of the startup, operation, or shutdown of any one or more of various aspects of the system 200 to facilitate safe and efficient operation. For example, the controller 114 may be in electrical communication at least with the electrochemical stack 216 and the power source 202. Continuing with this example, the controller 114 may interrupt power to the electrochemical stack 216 if an anomalous condition is detected. Further, or instead, the controller 114 may control the power to the electrochemical stack 216 after a startup protocol to reduce the likelihood of igniting a hydrogen-containing mixture in the electrochemical stack.

In certain implementations, the controller 114 may further, or instead, monitor one or more ambient conditions of the hydrogen generator 106 to facilitate taking one or more remedial actions before an anomalous condition results in damage to the system 200 and/or to an area near the system. In one particular example, given the potential damage that may be caused by the presence of an ignitable hydrogen-containing mixture within the electrochemical stack 216, the system 200 may include a plurality of gas sensors (referred to collectively as the plurality of gas sensors and individually as the first gas sensor, second gas sensor, or third gas sensor). Each of the plurality of gas sensors may include any one or more of various types of hydrogen sensors, such as one or more optical fiber sensors, electrochemical hydrogen sensors, thin-film sensors, and the like. Each one of the plurality of gas sensors may be calibrated to detect hydrogen concentration levels below the ignition limit of hydrogen to facilitate taking remedial action before an ignition event can occur. Toward this end, the controller 114 may be in electrical communication with each one of the plurality of gas sensors. The non-transitory computer-readable storage media of the controller 114 may have stored thereon instructions for causing one or more processors of the controller to interrupt electrical communication between the power source 202 and equipment in the electrochemical stack 216 based on a signal, received from one or more of the plurality of gas sensors and indicative of a dangerous hydrogen concentration. Additionally, or alternatively, the signal received from one or more of the plurality of gas sensors may indicate a rapid increase in hydrogen concentration. In general, the controller 114 may respond to any measured or detected condition of the hydrogen generator 106 and control one or more components of the generator accordingly.

In some implementations, the hydrogen generator 106 may be coupled to an external water source (e.g., water pipe, not shown) to receive a water supply suitable for meeting the demands of the electrochemical stack 216. The connection between the hydrogen generator 106 and the external water source may facilitate connection of the system 200 to an industrial water supply and, in some instances, to reduce the likelihood of damaging equipment in the event of a leak in the connection between the external water source. In still other implementations, the hydrogen generator 106 may include a recirculation circuit to receive an exit flow of water and oxygen from the anode portion of the electrochemical stack 216. One or more of the oxygen sensors 218 may be connected to or otherwise in communication with the hydrogen generator 106 to measure or determine an exit flow of oxygen from the generator. The levels of exit flow oxygen may provide an indication of an operating state of the generator and may also be used to indicate an unsafe operating condition of the generator.

One or more of various gas-liquid separators suitable for separating oxygen from excess water may be included in the oxygen processor 208. For example, the oxygen processor 208 may include a dryer, a condenser, or another device that separates oxygen from excess water through gravity. The excess water may settle along a bottom portion of the oxygen processor 208, and oxygen is collecting along the top. The oxygen collected by the oxygen processor 208 may be directed out of the hydrogen generator 106.

Further, embodiments may include a hydrogen processor 210, which may include a hydrogen circuit, a dryer, and a hydrogen pump. In use, a product stream consisting of hydrogen and water (e.g., water vapor) may move from the anode side of the electrochemical stack 216 to the inlet portion of a dryer. The dryer may be, for example, pressure swing adsorption (PSA), a temperature swing adsorption (TSA) system, or a hybrid PSA-TSA system. The dryer may include one or more beds of a water-adsorbent material, such as activated carbon, silica, zeolite, or alumina. As the product mixture consisting of hydrogen and water moves through from the inlet portion to an outlet portion of the dryer, at least a portion of the water may be removed from the product mixture through adsorption of either water or hydrogen in the bed of water-adsorbent material.

The hydrogen pump may be, for example, an electrochemical pump. As used in this context, an “electrochemical pump” shall be understood to include a proton exchange membrane (i.e., a PEM electrolyte) disposed between an anode and a cathode. The hydrogen pump may generate protons moveable from the anode through the proton exchange membrane to the cathode to form pressurized hydrogen. Thus, such an electrochemical pump may be particularly useful for recirculating hydrogen within the hydrogen circuit at least because the electrochemical pumping provided by the electrochemical pump separates hydrogen from water in the mixture delivered to the hydrogen pump via the pump conduit while also pressurizing the separated hydrogen to facilitate moving the pressurized hydrogen to the inlet portion of the dryer.

Some embodiments may include storage tank 212, which may include a plurality of hydrogen storage tanks to contain the hydrogen created from the hydrogen processor 210. The storage tank 212 may be used to store excess hydrogen created by the hydrogen processor 210 to be used or shipped to users at a later time. In some instances, the produced hydrogen may not be stored in a storage tank but may instead be directly provided to an end user or to a storage tank external to the hydrogen generator. The storage tank 212 may be used to contain hydrogen until shipped to users, such as industrial outputs, among other users.

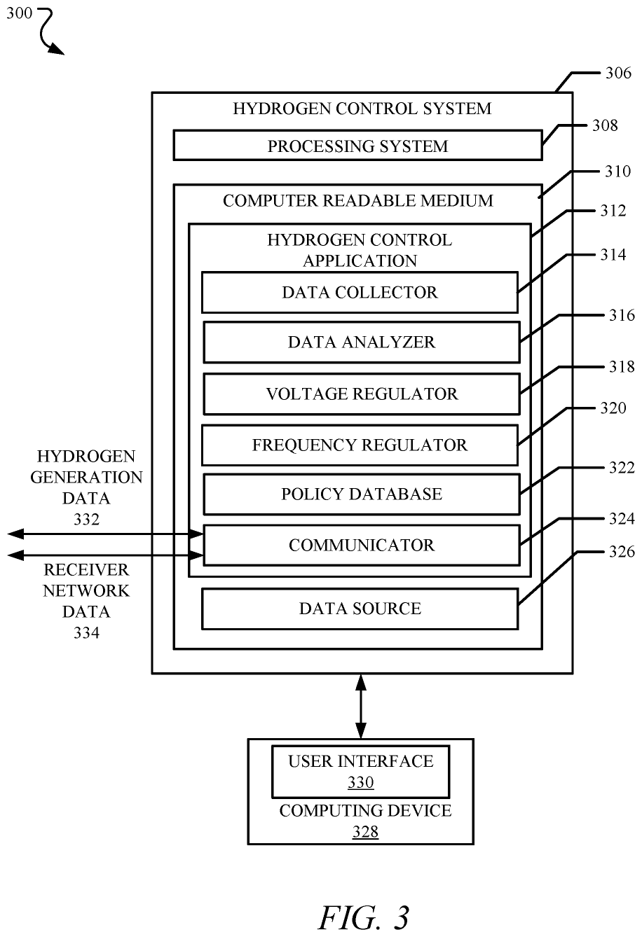

FIG. 3 illustrates an example block diagram of a controller for a hydrogen generation system to regulate power to the system in response to input voltage and/or frequency. In general, the system 300 may include a hydrogen control system 306. In one implementation, the hydrogen control system 306 may be a part of the hydrogen generation environment 100 of FIG. 1. As shown in FIG. 3, the hydrogen control system 306 may be in communication with a computing device 328 providing a user interface 330. As explained in more detail below, the hydrogen control system 306 may be accessible to various users to request hydrogen for any number of downstream receivers 112. In some instances, access to the hydrogen control system 306 may occur through the user interface 330 executed on the computing device 328.

The hydrogen generation system 306 may include a hydrogen generation application 312 executed to perform one or more of the operations described herein. The hydrogen generation application 312 may be stored in a computer readable media 310 (e.g., memory) and executed on a processing system 308 of the hydrogen generation system 306 or other type of computing system, such as that described below. For example, the hydrogen generation application 312 may include instructions that may be executed in an operating system environment, such as a Microsoft Windows™ operating system, a Linux operating system, or a UNIX operating system environment. By way of example and not limitation, non-transitory computer readable medium 310 comprises computer storage media, such as non-transient storage memory, volatile media, nonvolatile media, removable media, and/or non-removable media implemented in a method or technology for storage of information, such as computer readable instructions, data structures, program modules, or other data.

The hydrogen generation application 312 may also utilize a data source 326 of the computer readable media 310 for storage of data and information associated with the hydrogen generation system 306. For example, the hydrogen generation application 312 may store received data or inputs, processing details, and/or output information, and the like. As described in more detail below, data associated with hydrogen production, including historical hydrogen production, a normal voltage operating range for the electrochemical stack, rates of adjustment to production and/or reactive power of the power supply, and the like, may be stored and, in some instances, accessed via the user interface 330. Data associated with a safety procedure of the hydrogen generation may also be stored at the data source 326.

To provide power regulation to a hydrogen generation system in response to input voltage and/or frequency, the hydrogen generation application 312 may include several components that are be executed to control an operating state of the generator, and more particularly, to control a power signal provided to an electrolyzer of the system or a power grid connected to the system. For example, the hydrogen generation application 312 may include a data collector 314 to collect and store data from the hydrogen generator 106 and/or the receiver network 116. In some embodiments, the data collector 314 may utilize a communicator 324 of the hydrogen control application 312 to communicate with the hydrogen generator 106 and/or the receiver network 116 to receive said data. For example, the communicator 324 may communicate with the receiver network 116 to receive a request for hydrogen production received at a downstream system 112. The received request may be stored in the data source 326 (or some other data storage device) by the data collector 314. The hydrogen control application 312 may also, in response to receiving the request, transmit one or more control instructions to the hydrogen generator 106 to generate hydrogen for the downstream receiver 112. The data collector 314 may store data associated with any aspect of the generation of hydrogen, including hydrogen generation data 332 received from one or more hydrogen generators 106 and receiver network data 334 received from a receiver network corresponding to hydrogen generated for a downstream receiver 112.

Further embodiments may include a data analyzer 316 to analyze and/or otherwise process data stored by the data collector. In one implementation, the data analyzer 316 may obtain data from any of the databases managed by or otherwise in communication with the data collector 314. For example, the hydrogen control application 312 may maintain a database of input voltages and/or frequencies of a power signal received from a power grid or other power source, a database of threshold values associated with controlling a reactive power component of a hydrogen generator, a database of threshold values associated with controlling a production of a hydrogen generator, and any other database of information, data, or values as discussed below. This data may be processed by the data analyzer 316 of the hydrogen control application 312 to provide a voltage and/or frequency response of the hydrogen generation system.

The hydrogen control system 306 may also include a voltage regulator 318 to manage operations of one or more hydrogen generators 106 based on a determined voltage of an input power signal. In one particular example, the input power signal may be provided by a power grid connected to multiple loads such that an imbalanced reactive component of the power grid may reduce the efficiency of the grid. The control of the hydrogen generators 106 may therefore receive or provide some reactive power based on a need of the power grid to aid in balancing the reactive power of the grid. In one example, the hydrogen generators 106 may be controlled to adjust a reactive power of the generators based on a measurement of a voltage of an input power signal received from the power grid.

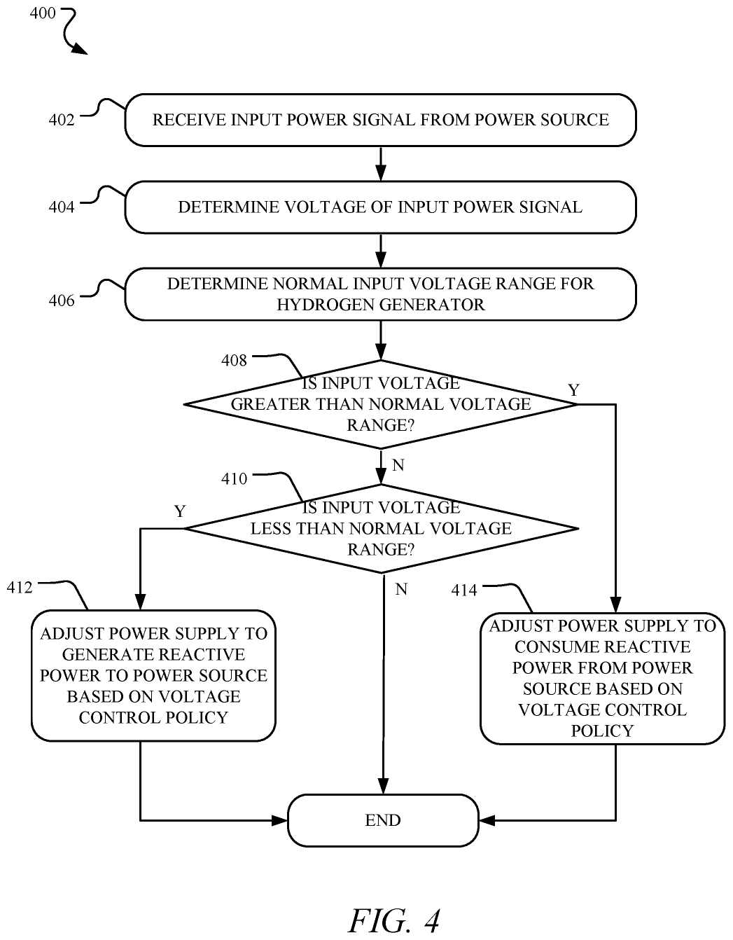

FIG. 4 illustrates a flowchart of a method 400 for adjusting a reactive power generated or consumed by a hydrogen generation system in response to an input voltage. In one implementation, the operations of the method 400 may be performed or executed by the voltage regulator 318 of the hydrogen control application 312 as executed by the control system 102. In general, however, the operations may be performed by any component or components of the hydrogen generation environment 100 of FIG. 1, including the controller 114 of the hydrogen generator 106 and/or a system of the receiver network 116.

At operation 402, an input power signal may be received at a hydrogen generator 106 from an input power source 110. In one implementation, the input power source 110 may be a power grid. However, other power sources 110 may also provide the input power signal, such as energy sources based on solar energy, wind energy, geothermal energy, biomass energy, hydropower energy, nuclear energy, internal combustion, gas turbines, steam turbines. Regardless of the input power source 110, a voltage of an input power signal provided by the source may be determined in operation 404. To measure the voltage of the input power signal, the power source 202 of the hydrogen generator 106 may include a voltmeter in connection with the input power resource 110 to measure the input voltage. The power source may, in general, include any type of measurement device or sensor for determining the input voltage. In still other implementations, the voltage of the input power signal may be provided to the hydrogen generating system 100 from a communication device associated with the power grid or other utility service.

At operation 406, a normal voltage range for the input power signal may be determined comprising an upper threshold value and/or a lower threshold value. In general, the controller 114 of the hydrogen generator 106 may instruct the power source 202 to provide power to the electrochemical stack 216 to generate hydrogen. The power source 202 may, in turn, convert the input power signal from the input power resource 110 to the requested hydrogen generating power signal. In many instances, the power signal provided to the hydrogen generator 106 from the input power resource 110 be within a normal range (ΔV) of power that includes an upper threshold value (+ΔV) of normal input voltage and a lower threshold value (−ΔV) of normal input voltage. The voltage regulator 318 may determine the normal range (ΔV) of input voltage power in many ways. For example, the voltage regulator 318 may receive the normal voltage range (ΔV) through the user interface 330 executed on the computing device 328. In another example, the normal voltage range (ΔV) may be received from the receiver network or from the grid itself through the communicator 324.

In yet another example, the normal voltage range (ΔV) may be generated or determined from data included in one or more historical databases. In particular, many diagnostics of the hydrogen generator 106 may be obtained over time and stored in one or more databases. Such diagnostics may include characteristics of the input power signal to the hydrogen generator 106 received from the input power resource 110, such as input voltage, input current, a frequency of the signal, and the like. The voltage regulator 318 may analyze the data of the historical databases and determine a normal voltage range (ΔV) over a period of time. The criteria for determining a normal voltage range may vary. For example, the analysis of the historical data may indicate that the power signal from a power grid is between 220 volts and 250 volts for 90% of the analyzed period of time. In this example, the normal voltage range (ΔV) may be determined at 30 volts, with an upper voltage value (+ΔV) of 250 volts and a lower voltage value (−ΔV) of 220 volts. In other instances, a voltage range that occurs more than 50% of the analyzed time may be determined to the normal voltage range (ΔV). In general, the normal voltage range (ΔV) may be any range of voltage values, with any upper voltage value (+ΔV) and any lower voltage value (−ΔV), including negative voltages. In some specific examples, the normal voltage range may be +/−10% of the operating voltage of the grid.

Regardless of if the normal voltage range (ΔV) is received or generated, the voltage measurement of the input power signal may be compared to the normal input voltage range (ΔV) at operation 408 to determine if the input voltage is greater than the normal voltage range. Continuing the above example, the voltage of the input power signal received from the power resource 110 may be 270 volts as measured or otherwise determined. If the voltage of the input power signal received from the power resource 110 is more than the upper threshold voltage value (+ΔV) (in this case, 250 volts), an operating condition of the hydrogen generator 106 may be adjusted in a first manner at operation 414 (described in more detail below). If the voltage of the input power signal received from the power resource 110 is not more than the upper threshold voltage value (+ΔV), it may be determined if the input voltage is less than the normal voltage range (ΔV) at operation 410. If the input voltage is not less than the normal voltage range (ΔV), the method 400 may end. Otherwise, an operating condition of the hydrogen generator 106 may be adjusted in a second manner at operation 412 (described in more detail below). As such, the operation of the hydrogen generator 106 may be adjusted based on the determined voltage of the input power signal received from the power resource 110 as compared to a normal voltage range (ΔV) for the input power signal.

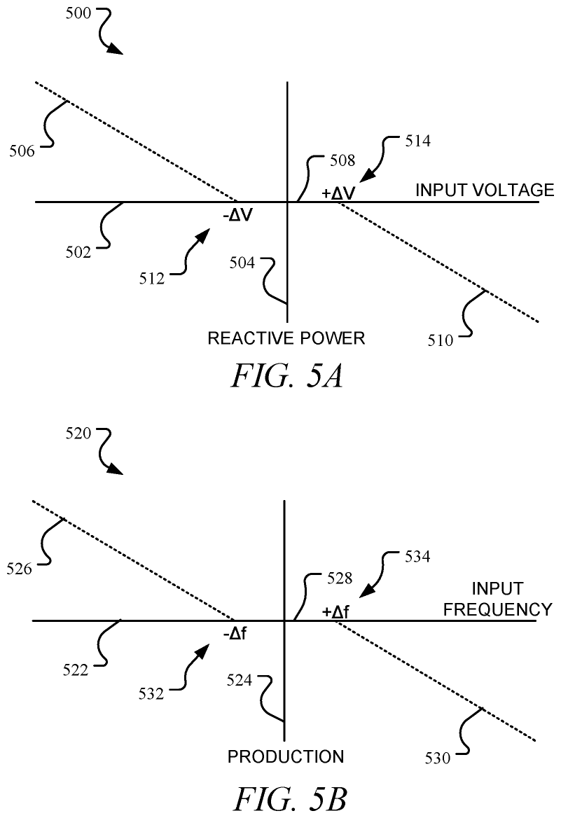

Returning to operation 414 for circumstances in which the determined voltage of the input power signal is greater than the normal voltage range (ΔV), one or more components of the power source 202 may be configured, adjusted, or altered to cause the hydrogen generator 106 to consume more reactive power from the power source. The adjustment to the power source 202 may be based on an adjustment policy maintained in a policy database 322 by the voltage regulator 318 or the hydrogen control application 312 in general. FIG. 5A illustrates one such adjustment policy for a hydrogen generator 106 to adjust a reactive power consumed by the generator in response to a voltage of an input power signal.

Graph 500 of FIG. 5A illustrates an example policy for controlling a hydrogen generation system 100 based on input voltage versus reactive power. In particular, the graph 500 includes a determined voltage 502 of an input power signal to a hydrogen generator along the x-axis and a reactive power consumed 504 by the hydrogen generator along the y-axis. Dotted lines 506 and 510 represent policy for controlling a hydrogen generation system 100 based on input voltage versus reactive power. For example, the slope of line 510 illustrates an amount of additional reactive power to be consumed by the hydrogen generator 106 based on a corresponding value of the voltage of the input power signal. Notably, no additional reactive power is consumed by the hydrogen generator 106 for input voltages between the upper voltage threshold value 514 and the lower voltage threshold value 512. Different policies for controlling an amount of consumed reactive power of the hydrogen generator 106 based on the input voltage from the power grid may be illustrated through other sloped lines or other shapes. For example, the reactive power consumed may be increased at a faster rate as the input voltage value increases. In another example, the relationship between the increase in the reactive power consumed and the input voltage may follow a curved function, such as an exponential curve. In general, the voltage regulator 318 may execute any type of policy for adjusting a reactive power consumed in relation to an increase in the input voltage received from the power grid.

The hydrogen generator 106 may adjust the reactive power consumption through various methods. For example, the power source 202 of the hydrogen generator 106 may include reactive-power compensation devices, such as, for example, capacitor banks, synchronous condensers, thyristor-controlled reactors (TCR), thyristor-switched capacitors (TSC), static var compensators (SVC), and/or static synchronous compensators (StatComs). The power electronics may, according to an internal voltage, exhibit capacitive properties (e.g., generating reactive power) or inductive properties (e.g., consuming reactive power). The amount of reactive power consumed or generated by the power electronics may be conducted by adjusting an internal voltage of the electronics. In some instances, the change in internal voltage of the electronics may be based on an instruction received from controller 114. In other instances, the electronics of the power source 202 may receive an instruction or signal from control system 102 to alter the internal voltage of the electronics and, in turn, adjust the generation or consumption of reactive power by the hydrogen generator 106. In general, power electronics 202 may be able to be change from exhibiting capacitive properties to inductive properties (and vice versa) relatively quickly, e.g., more quickly than other loads. As an example, power electronics 202 may be able to change from exhibiting capacitive properties to inductive properties (and vice versa) in under a second, e.g., in hundreds of milliseconds.

As noted, power electronics 202 may be used to generate or consume reactive power. For example, power electronics 202 may shift an angle between an input voltage signal of AC power and a current signal of AC power. For reactive power generation, power electronics 202 may shift an angle between an input voltage signal of AC power and a current signal of AC power, such that the current signal will be ahead relative to the voltage signal. Alternatively for reactive power consumption, power electronics 202 may shift an angle between a voltage signal of the input AC power and a current signal of the input AC power, such that the current signal will be delayed relative to the voltage signal. Further, as the power source 202 is shifting an angle between the input voltage signal of AC power and a current signal of AC power, it may also increase the magnitude of a current signal of AC power to maintain DC power to the electrochemical stack 216, and consequently hydrogen production. Thus, the electrochemical stack 216 can be controlled to generate or consume reactive power, e.g., by altering a magnitude of a voltage signal or a current signal provided to the electrochemical stack. In some cases, system 100 may be configured such that it is capable of providing extra capacity for reactive-power exchange even when hydrogen generator 106 is operating at full capacity.

Returning to the method 400 of FIG. 4, the components of the power source 202 may be adjusted as described above to cause the hydrogen generator 106 to consume more reactive power from the grid power source 110 at operation 414. The amount of adjustment to the power source 202 may be based on a voltage control policy, such as that illustrated in the graph 500 of FIG. 5A. Alternatively, if it is determined at operation 410 that the input voltage from the input power signal is less than the normal voltage range, the power source 202 may be adjusted to generate reactive power to provide back to the power grid input resource 110 at operation 412. Similar to above, the adjustment to the power source 202 to generate reactive power may be based on a voltage policy, such as that illustrated in the graph 500 of FIG. 5A. In particular, for input voltages (graphed along the x-axis 502) that are less than the lower threshold voltage value 512 of the normal voltage range, reactive power generated (graphed along the y-axis 504) may follow the dotted line 506. As shown, the amount of reactive power generated by the power source 202 of the hydrogen generator 106 may be proportional to the deviation of the input voltage from the lower threshold voltage value 512. However, as above, the relationship between the increase in the reactive power generated and the input voltage may follow a curved function. In general, the voltage regulator 318 may execute any type of policy for adjusting a reactive power consumed in relation to a decrease in the input voltage received from the power grid below the lower threshold voltage value 512.

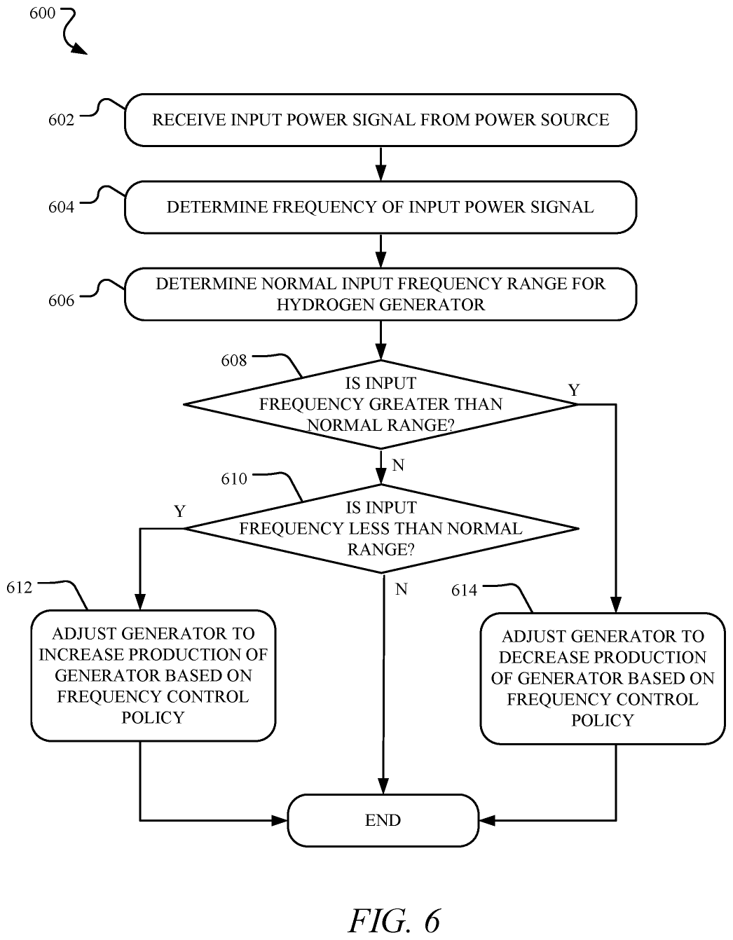

In addition, the hydrogen generator 106 may be controlled to adjust a reactive power of the generators based on a measurement of a frequency of an input power signal received from the power grid input resource 110. For example, FIG. 6 illustrates a flowchart of a method 600 for adjusting a reactive power generated or consumed by a hydrogen generation system in response to a frequency of an input power signal. In this implementation, the reactive power generated or consumed by a hydrogen generator 106 may be controlled through the production of an electrochemical stack 216 of the generator. As mentioned above, the electrochemical stack 216 can be controlled to generate or consume reactive power, e.g., by adjusting a magnitude of a voltage signal or a current signal provided to the electrochemical stack. Through a control of the power signal to the electrochemical stack 216 (which in turn controls the production of hydrogen by the electrochemical stack), an amount of reactive power may be consumed by the hydrogen generator.

In one implementation of the method 600, the operations may be performed or executed by the frequency regulator 320 of the hydrogen control application 312 as executed by the control system 102. In general, however, the operations may be performed by any component or components of the hydrogen generation environment 100 of FIG. 1, including the controller 114 of the hydrogen generator 106 and/or a system of the receiver network 116.

At operation 602, an input power signal may be received at a hydrogen generator 106 from an input power source 110. As above, the input power source 110 may be a power grid or another power sources 110. Regardless of the input power source 110, a frequency of the input power signal provided by the source may be determined in operation 604. To measure the frequency of the input power signal, the power source 202 of the hydrogen generator 106 may include any type of measurement device or sensor for determining the frequency of the input power signal from the power grid. In still other implementations, the frequency of the input power signal may be provided to the hydrogen generating system 100 from a communication device associated with the power grid or other utility service.

At operation 606, a normal frequency range (Δf) for the input power signal may be determined comprising an upper threshold value (+Δf) and/or a lower threshold value (−Δf). For example, it may be determined that a normal frequency range (Δf) for the input power signal may be between an upper threshold value (+Δf) and a lower threshold value (−Δf). In some specific examples, the normal frequency range may be +/−0.5% of the operating frequency of the grid or +/−0.8% of the operating frequency of the grid. As above, the frequency regulator 320 may receive the normal frequency range (Δf), such as through the user interface 330 executed on the computing device 328, or may determine the normal range from data included in one or more historical databases. Regardless of if the normal frequency range (Δf) is received or generated, the frequency measurement of the input power signal may be compared to the normal input frequency range (Δf) at operation 608 to determine if the input frequency is greater than the normal frequency range. If the frequency of the input power signal received from the power resource 110 is more than the upper threshold frequency value (+Δf), an operating condition of the hydrogen generator 106 may be adjusted in a first manner at operation 614. If the frequency of the input power signal received from the power resource 110 is not more than the upper threshold frequency value (+Δf), it may be determined if the input frequency is less than the normal frequency range (Δf) at operation 610. If the input frequency is not less than the normal frequency range (Δf), the method may end. Otherwise, an operating condition of the hydrogen generator 106 may be adjusted in a second manner at operation 612. As such, the operation of the hydrogen generator 106 may be adjusted based on the determined frequency of the input power signal received from the power resource 110 as compared to a normal frequency range (Δf) for the input power signal.

At operation 614, the production of the electrochemical stack 216 may be adjusted in response to the determined frequency to cause the hydrogen generator 106 to decrease production of hydrogen. For example, the controller 114 may instruct the power source 202 to provide less power to the electrochemical stack 216 to decrease the hydrogen production. The adjustment to the production may be based on an adjustment policy maintained in a policy database 322 by the frequency regulator 320 or the hydrogen control application 312 in general. FIG. 5B illustrates one such adjustment policy for a hydrogen generator 106 to adjust a production of the hydrogen generator in response to a determined frequency of an input power signal.

In particular, the graph 520 includes a determined input frequency 522 of an input power signal to a hydrogen generator along the x-axis and a hydrogen production 524 of the generator along the y-axis. Dotted lines 526 and 530 represent policy for controlling a hydrogen generation system 100 based on input frequency. For example, the slope of line 530 illustrates an amount of additional production of the hydrogen generator 106 based on a corresponding value of the input frequency. As above, the production is not altered for input frequencies between the upper frequency threshold value 534 and the lower frequency threshold value 532. Different policies for controlling an amount of production of the hydrogen generator 106 based on the input frequency from the power grid may be illustrated through other sloped lines or other shapes. In general, however, any type of policy may be executed for adjusting a production of a hydrogen generator in relation to an increase in the input frequency received from the power grid.

Returning to the method 600, the production of the electrochemical stack 216 may be adjusted in response to the frequency of the input power signal received from the input power resource 110. For example, the hydrogen production may be decreased for circumstances in which the frequency of the input power signal is greater than the upper threshold frequency value (+Δf) 534 at operation 614. Alternatively, if it is determined at operation 610 that the input frequency from the input power signal is less than the lower threshold frequency value (−Δf) 532, the production of the electrochemical stack 216 may be increased at operation 612. In this manner, the production of the hydrogen generator 106 may be adjusted based on the frequency of the input power signal received from the power grid input resource 110.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present systems and methods, which, as a matter of language, might be said to fall therebetween.

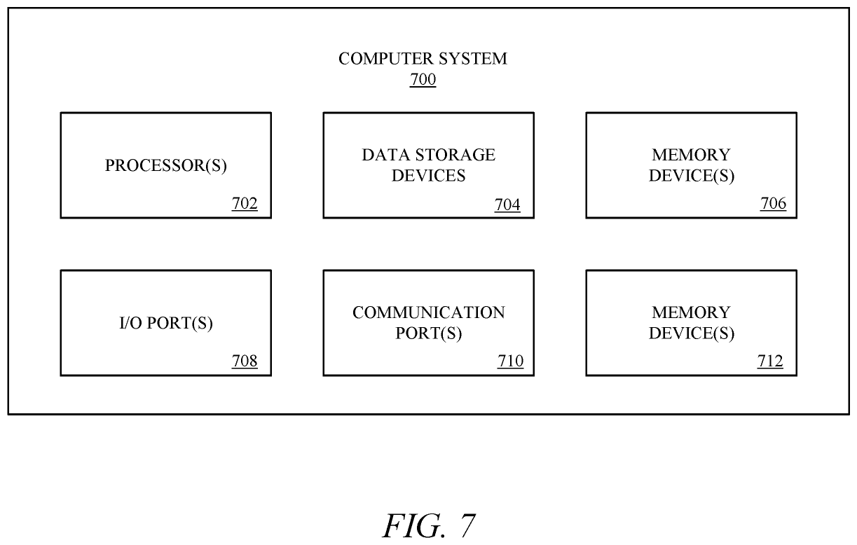

Referring to FIG. 7, a detailed description of an example computing system 700 having one or more computing units that may implement various systems and methods discussed herein is provided. The computing system 700 may be part of a controller 114, may be in operable communication with various implementation discussed herein, may run various operations related to the method discussed herein, and may be part of overall systems discussed herein. The computing system 700 may be applicable to, for example, the controller 114 discussed with respect to the various figures and may be used to implement the various methods described herein. It will be appreciated that specific implementations of these devices may be of differing possible specific computing architectures, not all of which are specifically discussed herein but will be understood by those of ordinary skill in the art. It will further be appreciated that the computer system may be considered and/or include an ASIC, FPGA, microcontroller, or other computing arrangement. In such various possible implementations, more or fewer components discussed below may be included, interconnections and other changes made, as will be understood by those of ordinary skill in the art.

The computer system 700 may be a computing system that is capable of executing a computer program product to execute a computer process. Data and program files may be input to the computer system 700, which reads the files and executes the programs therein. Some of the elements of the computer system 700 are shown in FIG. 7, including one or more hardware processors 702, one or more data storage devices 704, one or more memory devices 706, and/or one or more ports 708-712. Additionally, other elements that will be recognized by those skilled in the art may be included in the computing system 700 but are not explicitly depicted in FIG. 7 or discussed further herein. Various elements of the computer system 700 may communicate with one another by way of one or more communication buses, point-to-point communication paths, or other communication means not explicitly depicted in FIG. 7. Similarly, in various implementations, various elements disclosed in the system may or not be included in any given implementation.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The presently described technology in various possible combinations may be implemented, at least in part, in software stored on the data stored device(s) 704, stored on the memory device(s) 706, and/or communicated via one or more of the ports 708-712, thereby transforming the computer system 700 in FIG. 7 to a special purpose machine for implementing the operations described herein.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708, a communication port 710, and a sub-systems port 712, for communicating with other computing, network, or vehicle devices. It will be appreciated that the ports 708-712 may be combined or separate and that more or fewer ports may be included in the computer system 700. The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. In some examples, such inputs may be distinct from the various system and method discussed with regard to the preceding figures. Similarly, the output devices may convert electrical signals received from computing system 700 via the I/O port 708 into signals that may be sensed or used by the various methods and system discussed herein. The input device may be an alphanumeric input device, including alphanumeric and other keys for communicating information and/or command selections to the processor 702 via the I/O port 708.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing device 700.

In one implementation, a communication port 710 may be connected to a network by way of which the computer system 700 may receive network data useful in executing the methods and systems set out herein as well as transmitting information and network configuration changes determined thereby. The communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate with one or more other machines, either directly over a point-to-point communication path, over a wide area network (WAN) (e.g., the Internet), over a local area network (LAN), over a cellular (e.g., third generation (3G), fourth generation (4G), fifth generation (4G)) network, or over another communication means.

The system set forth in FIG. 7 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Various embodiments of the disclosure have been discussed in detail. While specific implementations are discussed, it should be understood that this is done for illustration purposes only. A person skilled in the relevant art will recognize that other components and configurations may be used without parting from the spirit and scope of the disclosure. Thus, the description and drawings herein are illustrative and are not to be construed as limiting. Numerous specific details are described to provide a thorough understanding of the disclosure. However, in certain instances, well-known or conventional details have not been described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Thus, references to one or an embodiment in the present disclosure can be references to the same embodiment or any embodiment; and such references mean at least one of the embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.”

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the invention, embodiments, or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

In the present disclosure, the term “real power” may refer to the portion of instantaneous power that, averaged over a complete cycle of the AC waveform, results in net transfer of energy in one direction. Real power may be described in terms of watts (W). In the present disclosure, the term “reactive power” may refer to the portion of instantaneous power that results in no net transfer of energy, but instead oscillates between the source and load in each cycle due to stored energy in the reactive elements. Reactive power may be described in terms of volt-amperes reactive (var). In the present disclosure, the term “power factor” may refer to the ratio between real power and apparent power.

In the present disclosure, the term “generating reactive power,” and like terms, may refer to delaying a voltage signal relative to a current signal. A capacitive element (e.g., a bank of capacitors) may generate reactive power. In some cases, a load (e.g., a capacitive load) may generate reactive power to cause the voltage signal to be more in phase with the current signal, i.e., decreasing a total amount of reactive power in a system.

In the present disclosure, the term “consuming reactive power,” and like terms, may refer to delaying a current signal relative to a voltage signal. An inductive element (e.g., a generator) may consume reactive power. In some cases, a load (e.g., an inductive load) may consume reactive power to cause the current signal to be more in phase with the voltage signal, i.e., decreasing a total amount of reactive power in a system.

What is claimed is:

1. A hydrogen generation system comprising:
a hydrogen generator comprising:
an electrochemical stack producing hydrogen; and
a power source receiving an input power signal from an input energy source and in electrical communication with the electrochemical stack; and
a control system comprising a processor and a non-transitory computer-readable medium encoded with instructions, which when executed by the processor, cause the processor to:
determine a value of a characteristic of the input power signal received from the input energy source;
obtain a pre-determined range of values of the hydrogen generator corresponding to the characteristic of the input power signal, the pre-determined range of values comprising an upper threshold value of the characteristic and a lower threshold value of the characteristic; and
alter, based on the value of the characteristic of the input power signal being greater than the upper threshold value of the characteristic or less than the lower threshold value of the characteristic, a consumption of reactive power of the input energy source by the hydrogen generator.

2. The hydrogen generation system of claim 1, wherein the input energy source is a utility power grid.

3. The hydrogen generation system of claim 1, wherein the input energy source comprises one of a solar panel array, a wind farm, or a geothermal energy source.

4. The hydrogen generation system of claim 1, wherein the value of the characteristic of the input power signal received from the input energy source is a voltage of the input power signal.

5. The hydrogen generation system of claim 4, wherein altering the consumption of reactive power of the input energy source by the hydrogen generator comprises adjusting the power source to consume reactive power when the voltage of the input power signal is greater than an upper threshold voltage value.

6. The hydrogen generation system of claim 4, wherein altering the consumption of reactive power of the input energy source by the hydrogen generator comprises adjusting the power source to generate reactive power when the voltage of the input power signal is less than a lower voltage threshold value.

7. The hydrogen generation system of claim 4, wherein altering the consumption of reactive power of the input energy source by the hydrogen generator is based on a voltage control policy of the control system.

8. The hydrogen generation system of claim 1, wherein the value of the characteristic of the input power signal received from the input energy source is a frequency of the input power signal.

9. The hydrogen generation system of claim 8, wherein altering the consumption of reactive power of the input energy source by the hydrogen generator comprises adjusting a power signal to the electrochemical stack to decrease hydrogen production when the frequency of the input power signal is greater than an upper threshold frequency value.

10. The hydrogen generation system of claim 8, wherein altering the consumption of reactive power of the input energy source by the hydrogen generator comprises adjusting a power signal to the electrochemical stack to increase hydrogen production when the frequency of the input power signal is less than a lower threshold frequency value.

11. The hydrogen generation system of claim 8, wherein altering the consumption of reactive power of the input energy source by the hydrogen generator is based on a frequency control policy of the control system.

12. A method comprising:
controlling a reactive power consumed by a hydrogen generator receiving an input power signal from an input energy source, the hydrogen generator comprising:
an electrochemical stack producing hydrogen; and
a power source receiving the input power signal from the input energy source and in electrical communication with the electrochemical stack;
determining a value of a characteristic of the input power signal received from the input energy source;
determining a range of values of the hydrogen generator corresponding to the characteristic of the input power signal, the range of values comprising an upper threshold value of the characteristic and a lower threshold value of the characteristic; and
transmitting, to the hydrogen generator, one or more instructions to alter, based on the value of the characteristic of the input power signal being greater than the upper threshold value of the characteristic or less than the lower threshold value of the characteristic, a consumption of reactive power of the input energy source by the hydrogen generator.

13. The method of claim 12, wherein the range of values of the hydrogen generator corresponding to the characteristic of the input power signal is based on historical data of the operation of the hydrogen generator.

14. The method of claim 12, wherein the value of the characteristic of the input power signal received from the input energy source is one of a voltage of the input power signal or a frequency of the input power signal.

15. The method of claim 14, wherein altering the consumption of reactive power of the input energy source by the hydrogen generator comprises adjusting the power source to consume reactive power when the voltage of the input power signal is greater than an upper threshold voltage value.

16. The method of claim 14, wherein altering the consumption of reactive power of the input energy source by the hydrogen generator comprises adjusting the power source to generate reactive power when the voltage of the input power signal is less than a lower voltage threshold value.

17. The method of claim 14, wherein altering the consumption of reactive power of the input energy source by the hydrogen generator comprises adjusting a power signal to the electrochemical stack to decrease hydrogen production when the frequency of the input power signal is greater than an upper threshold frequency value.

18. The method of claim 14, wherein altering the consumption of reactive power of the input energy source by the hydrogen generator comprises adjusting a power signal to the electrochemical stack to increase hydrogen production when the frequency of the input power signal is less than a lower threshold frequency value.

19. A non-transitory computer-readable storage medium having computer-executable program instructions stored thereon that when executed by a processor, cause a computing device to perform:
controlling a reactive power consumed by a hydrogen generator receiving an input power signal from an input energy source, the hydrogen generator comprising:
an electrochemical stack producing hydrogen; and
a power source receiving the input power signal from the input energy source and in electrical communication with the electrochemical stack;
determining a value of a characteristic of the input power signal received from the input energy source;
determining a range of values of the hydrogen generator corresponding to the characteristic of the input power signal, the range of values comprising an upper threshold value of the characteristic and a lower threshold value of the characteristic; and
transmitting, to the hydrogen generator, one or more instructions to alter, based on the value of the characteristic of the input power signal being greater than the upper threshold value of the characteristic or less than the lower threshold value of the characteristic, a consumption of reactive power of the input energy source by the hydrogen generator.

20. The non-transitory computer-readable storage medium of claim 19, wherein the input energy source is a utility power grid.
